(19) United States
(12) Patent Application Publication
(10) Pub. No.: US 2017/0198448 A1
(43) Pub. Date: Jul. 13, 2017

(54) PARKING BARRIER HAVING ADVERTISING FUNCTION

(71) Applicant: HANWOONG TECH CO., LTD., Seoul (KR)

(72) Inventor: Young Gy HAN, Seoul (KR)

(73) Assignee: HANWOONG TECH CO., LTD., Seoul (KR)

(21) Appl. No.: 15/324,502

(22) PCT Filed: Aug. 31, 2015
(86) PCT No.: PCT/KR2015/009127

§ 371 Date: Jan. 6, 2017

(30) Foreign Application Priority Data
Sep. 1, 2014 (KR) 10-2014-0115596

(51) Int. Cl. E01F 13/06; E06B 3/48; G09F 19/22; E05F 15/60; E05F 15/77; E01F 13/04; E05D 15/04

(52) U.S. Cl. CPC E01F 13/06; E01F 13/042; E06B 3/48; E05D 15/04; E05F 15/60; E05F 15/77; G09F 19/22

(57) ABSTRACT

The present invention relates to a parking barrier having an advertising function, and the present invention relates to a parking barrier in which vertical panels printed with an advertisement are arranged and provided so as to be supported by a cross bar, thereby having an advertising function. The parking barrier having an advertising function according to the present invention comprises; a driving unit; an upper cross bar provided so as to be rotatable by the driving unit, thereby controlling vehicles; and a plurality of vertical panels provided at the upper cross bar such that upper ends thereof are rotatable, thereby maintaining a vertical state by the weight thereof, wherein a rotating shaft and the revolving shaft so as to be engaged with each other such that the vertical panels revolve on the revolving shaft when the upper cross bar rotates so as to stand upright.

### TECHNICAL FIELD

The present disclosure generally relates to a parking barrier having an advertising function. More particularly, the present disclosure related to a parking barrier having an advertising function in which an array of vertical members on which an advertisement is printed are supported by arms.

The parking barrier according to the present disclosure is a technology applicable to hotels, residential-commercial buildings, supermarkets, theaters, airports, stadiums, exhibition halls, apartment complexes, toll parking facilities, and the like.

### BACKGROUND ART

A parking barrier generally refers to an apparatus designed to control the passage of vehicles entering and exiting a parking area.

Typically, a parking barrier is installed at a point at which vehicles enter or exit such a parking area. Such a parking barrier commonly includes an arm and a driving unit.

The arm is horizontally disposed at a certain height to block the passage of vehicles at ordinary times. The driving unit is connected to one end of the arm such that the driving unit can pivot the arm. This configuration forms a part of a typical parking barrier system.

The driving unit has an electrically powered system, and is disposed at one end portion of the arm to pivot the arm from a horizontal position to a vertical position and vice versa, through an angle of 90°.

Although the driving unit can operate automatically, the driving unit is generally operated in a semi-automatic mode for parking fee collection. When a parking manager collects parking fees, the parking manager may manually operate the arm of a parking barrier at the exit, while a parking barrier at the entrance operates automatically. The parking barrier at the entrance detects vehicles automatically, and when a parking ticket is collected by a driver, or upon the license number of a vehicle being identified, the arm is raised to a vertical position.

The arm typically has the shape of a long bar, and is typically painted with stripes or other patterns having a plurality of colors in order to attract attention.

Since the arm is a part of the device that has the shape of a long bar and must be pivoted from a horizontal position to a vertical position and vice versa, it is difficult to print an advertisement on the arm.

The arm may be formed as a wide plate such that an advertisement can be printed thereon. In this case, however, it may be difficult to operate the arm, and there may be some undesirable problems in terms of design.

### RELATED ART DOCUMENT

Patent Document 1: Korean Patent Application Publication No. 10-2003-0047922

### DISCLOSURE

### Technical Problem

Various aspects of the present disclosure provide a parking barrier having an advertising function able to set an advertisement provided on a plurality of advertising panels to be exposed in front of a vehicle when blocking the passage of the vehicle and to rotate the plurality of advertising panels sideways when allowing passage of the vehicle.

### Technical Solution

According to an aspect of the present disclosure, a parking barrier having an advertising function includes: a driving unit; an upper arm controlling passage of vehicles, the upper arm being pivotable by the driving unit; and a plurality of vertical panels. The top portion of each of the plurality of vertical panels is rotatably coupled to the upper arm such that each of the plurality of vertical panels stays in an upright position due to the weight thereof.

Each of the plurality of vertical panels may include a pivot shaft having a bevel gear and a central rotary shaft having a bevel gear engaging with the bevel gear of the pivot shaft, whereby each of the plurality of vertical panels rotates on the central rotary shaft in response to the upper arm being pivoted to an upright position.

When the upper arm pivots from a horizontal position in which the passage of vehicles is blocked to an upright position in which the free end of the upper arm is raised as high as possible, the plurality of vertical panels may rotate about the central rotary shaft through 90°.

The parking barrier may further include a lower arm rotatably connected to the bottom portion of each of the plurality panels, thereby supporting the plurality of vertical panels.

The parking barrier may further include a connecting support extending in the top-bottom direction between the upper arm and the lower arm to connect and support the upper arm and the lower arm. The top portion and the bottom portion of the connecting support are rotatably coupled to the upper arm and the lower arm.

The parking barrier may further include a plurality of light-emitting diode (LED) lamps disposed on the plurality of vertical panels.

The plurality of LED lamps may be turned on and off by a controller. The controller controls the plurality of LED lamps based on a signal received via wireless communication.

### Advantageous Effects

As set forth above, the present disclosure has the following effects.

(1) The parking barrier according to the present disclosure serves as not only a parking barrier but also an advertising plate by allowing an advertisement to be constantly exposed at a height corresponding to the level of a driver in a vehicle.

(2) When the arms are in the upright position, the advertising plate, the height and area of which correspond to those of the vehicle, are rotated sideways and overlap each other without unnecessarily occupying a space, such that the parking barrier having an advertising function according to the present disclosure can perform its original function as a parking barrier.

(3) In the parking barrier having an advertising function according to the present disclosure, since the plurality of vertical panels forming the advertising plate are rotated sideways simultaneously with the arms being pivoted upwardly, two operations can be carried out at the same time, thereby reducing the operating time of the parking barrier.

### DESCRIPTION OF DRAWING

FIG. 1 is a perspective view illustrating a parking barrier having an advertising function according to an exemplary embodiment;

FIG. 2 is a front elevation view illustrating the parking barrier having an advertising function according to the exemplary embodiment, in which state the passage of a vehicle is blocked by the parking barrier;

FIG. 3 is a front elevation view illustrating the parking barrier having an advertising function according to the exemplary embodiment, in which the arms are being raised;

FIG. 4 is a front elevation view illustrating the parking barrier having an advertising function according to the exemplary embodiment, in which the arms have been completely raised, allowing the passage of a vehicle;

FIG. 5 is a top plan view illustrating the parking barrier having an advertising function according to the exemplary embodiment;

FIG. 6 is an exploded perspective view illustrating a vertical panel among the plurality of vertical panels and an assembly for allowing the vertical panel to pivot and rotate in the parking barrier having an advertising function according to the exemplary embodiment;

FIG. 7 is perspective views illustrating the operation of the plurality of vertical panels in the parking barrier having an advertising function according to the exemplary embodiment;

FIG. 8 is a front elevation view illustrating a parking barrier according to another exemplary embodiment; and

FIG. 9 is a block diagram illustrating the concept of controlling the light-emitting diode (LED) lamps of the parking barrier according to another exemplary embodiment.

### BEST MODE

The foregoing and other objects, features, and advantages of the present disclosure will be more apparent from the following Detailed Description. Hereinafter, exemplary embodiments of the present disclosure will be described in detail with reference to the accompanying drawings.

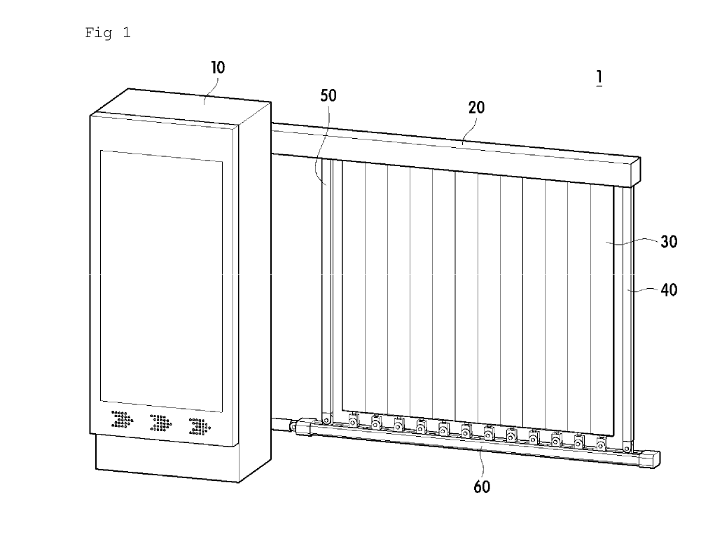

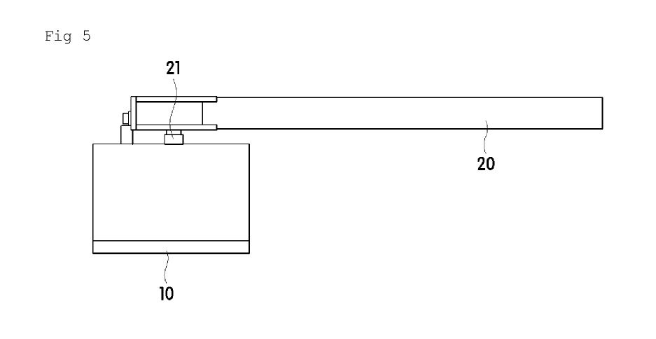

Referring to FIG. 1 to FIG. 7, a parking barrier 1 having an advertising function according to an exemplary embodiment includes a driving unit (not shown), an upper arm 20, a lower arm 60, and a plurality of vertical panels 30.

The driving unit can supply rotational driving force from a motor. The driving unit may include the motor and gear components transferring the rotational driving force of the motor. This configuration will be fully apparent to a person skilled in the art from known technologies.

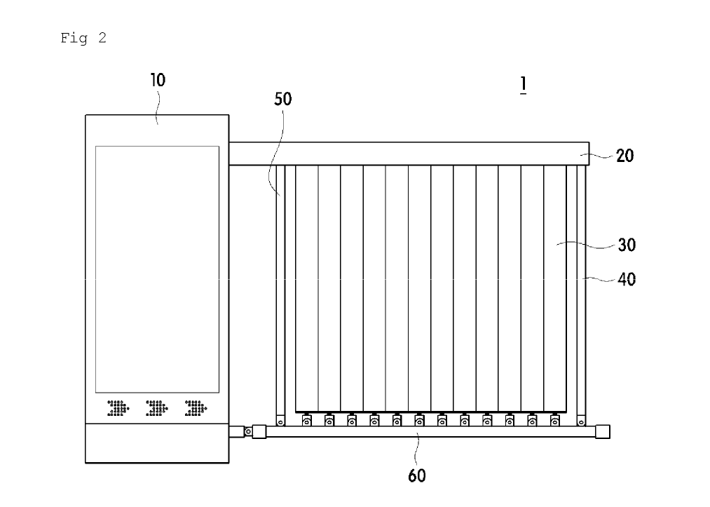

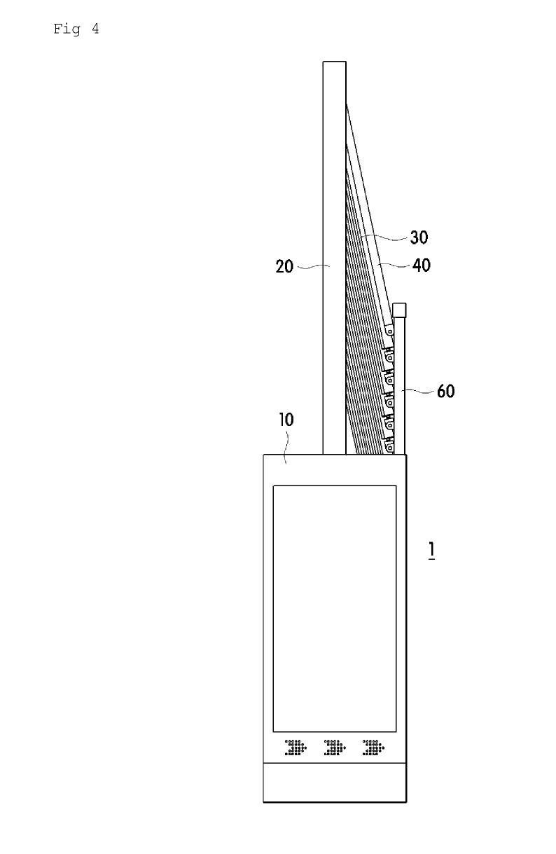

The driving unit provides the rotational driving force to pivot the upper arm 20 from a horizontal position illustrated in FIG. 1 and FIG. 2 to an upright position (vertical position) illustrated in FIG. 4, or vice versa.

The driving unit is disposed within a control box 10 in which a pivot shaft 21 of the upper arm 20 is disposed. In addition to the driving unit, other electrical parts are disposed within the control box 10.

The upper arm 20 can be rotated by the driving unit in order to control vehicular access. That is, the upper arm 20 controls vehicles in a horizontal position, but opens an entrance in a raised position. This operation is identical those well known in the art.

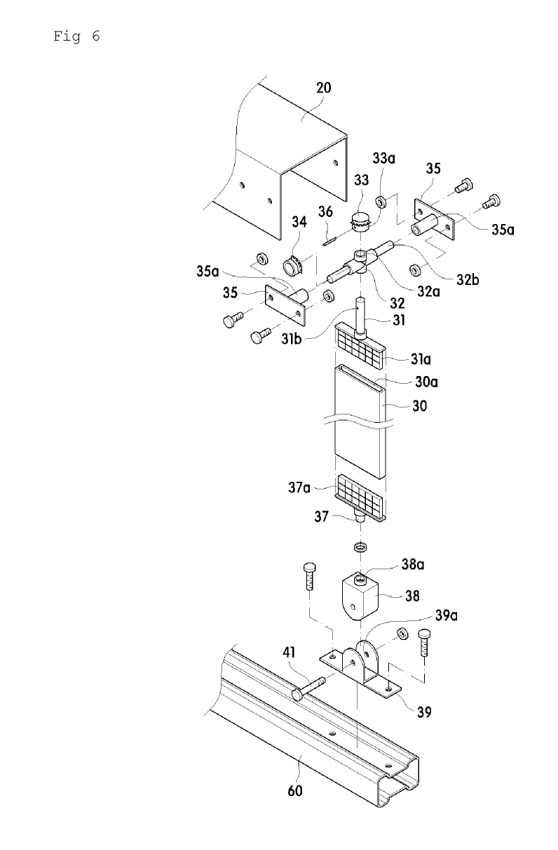

The upper arm 20 has an oblong cross-sectional shape, with the bottom being open. This configuration can protect the top portion of each of the vertical panels 30 while allowing the top portion of each of the vertical panels 30 to be rotatably connected to the upper arm 20. Referring to FIG. 6, a pair of assembly panels 35 each having a bushing 35a are illustrated as being attached to a pair of inner side surfaces of the upper arm 20 that face each other, and a pivot shaft 32 is fitted into the two bushings 35a, allowing each of the vertical panels 30 to rotate.

The top portion of each of the vertical panels 30 is rotatably coupled to the upper arm 20, such that each of the vertical panels 30 stays in the vertical position due to the weight thereof. Since the bottom portion of each of the vertical panels 30 is attached to the lower arm 60, each of the vertical panels 30 is forced to remain in the upright position.

A central rotary shaft 31 and the pivot shaft are provided on the top portion of each of the vertical panels 30. The central rotary shaft 31 has a bevel gear 33, and the pivot shaft 32 has a bevel gear 34 engaging with the bevel gear 33 of the central rotary shaft 31. With this configuration, the plurality of vertical panels rotate on the central rotary shaft 31 in response to the upper arm 20 being pivoted to the upright position.

Referring to FIG. 6, both end portions 32b of the pivot shaft 32 are rotatably fitted into the bushings 35a disposed in the front-rear direction. The pivot shaft 32 has a through-hole 32a in the central portion through which the central rotary shaft 31 extends. The central rotary shaft 31 extends through the through-hole 32a of the pivot shaft 32, with the top portion thereof being fitted into the bevel gear 33, and a pin 36 is fitted into pinholes 33a of the bevel gear 33 and a pinhole 31b of the central rotary shaft 31. In this manner, the central rotary shaft 31 and the central rotary shaft 31 are attached to each other.

A fitting assembly portion 31a is disposed on the lower portion of the central rotary shaft 31. The fitting assembly portion 31a is fitted into a recess 30a formed in a corresponding vertical panel 30 among the plurality of vertical panels 30, such that the central rotary shaft 31 is attached to the corresponding vertical panel 30. With this configuration, the vertical panel 30 can rotate on the central rotary shaft 31.

The end portions 32a of the pivot shaft 32 extend in the front-rear direction, and the bevel gear 34 disposed on one of the end portions 32a is fixedly coupled to the corresponding bushing 35a. The bevel gear 34 engages with the bevel gear 33 disposed on the central rotary shaft 31.

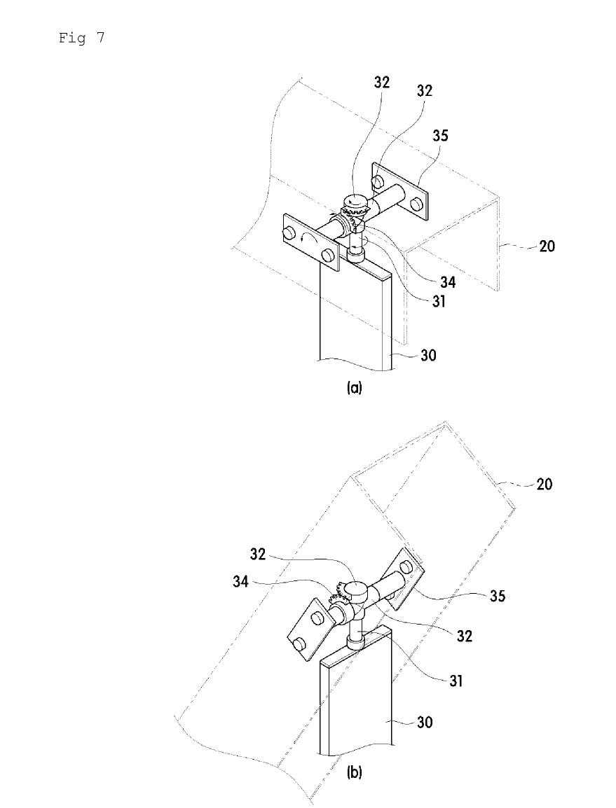

Typical bevel gears have teeth on the entire outer circumference in order to transfer rotational driving force at a right angle. In the present disclosure, teeth are provided on portions of the bevel gears 33 and 34, as illustrated in FIG. 7A and FIG. 7B. Since the angle of rotation is limited to 90°, the teeth are not required to be formed on the entire outer circumferences of the bevel gears 33 and 34.

Since the bevel gear 34 is fixedly fitted into the bushing 35a, when the upper arm 20 pivots, the bevel gear 34 fixed to the bushing 35a moves along with the upper arm 20.

Since the plurality of vertical panels 30 are continuously disposed between the upper and lower arms 20 and 60, an advertisement or the like printed on the plurality of vertical panels 30 is exposed externally in the horizontal position of the upper arm 20, thereby achieving an advertising effect.

A central rotary shaft 37 is attached to the bottom portion of each of the vertical panel 30 by means of a fitting assembly portion 37a. The lower central rotary shaft 37 is rotatably attached to a hole 38a of a rotary block 38.

The rotary block 38 is rotatably attached to a bracket 39 by means of a pivot shaft bolt 41 fitted into a hole 39a of the bracket 39. The bracket 39 is fixedly attached to the lower arm 60.

Since the bottom portions of the plurality of panels 30 are attached to the lower arm 60, the lower arm 60 serves to support the plurality of panels 30 from below.

Connecting supports 40 and 50 are rotatably disposed between the upper and lower arms 20 and 60. The top and bottom portions of the connecting supports 40 and 50 are rotatably coupled to the upper and lower arms 20 and 60, thereby connecting and supporting the upper and lower arms 20 and 60.

Referring to FIG. 2, the upper arm 20 is illustrated in the horizontal position to block the passage of vehicles. In this state, the plurality of vertical panels are not rotated at all, such that an advertisement printed on the plurality of vertical panels 30 is exposed to the front, thereby providing an advertising effect.

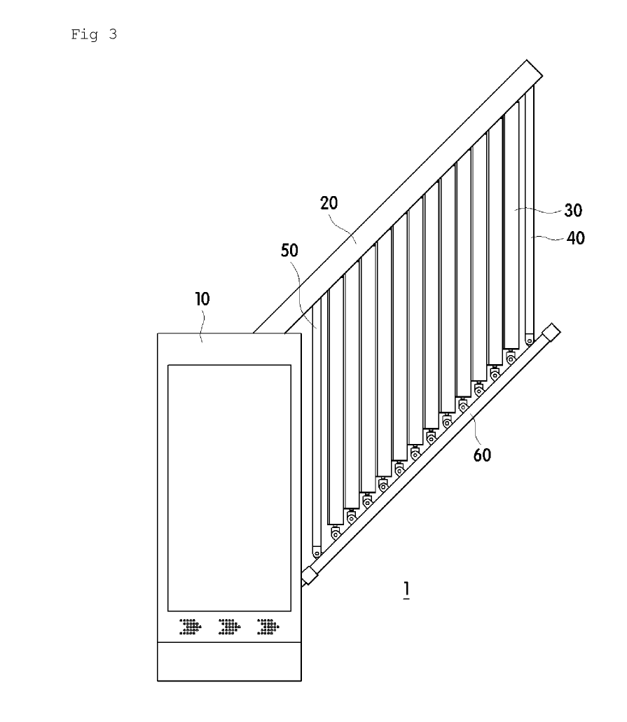

When the driving unit (not shown) operates due to a vehicular access or the like, the free end of the upper arm 20 pivots upwardly about the pivot shaft 21, converted to the position illustrated in FIG. 3.

At this time, each of the plurality of vertical panels 30 is rotated about the pivot shafts 32 by the angle of rotation of the upper arm 20, i.e. about 45°, while remaining in the upright position. In addition, each of plurality of vertical panels 30 is also rotated about the central rotary shaft 31 by about 45°, since the bevel gear 33 is engaged with the bevel gear 34. This consequently changes the image of the advertisement printed on the plurality of vertical panels 30.

Referring to FIG. 4, the upper arm 20 is further pivoted to the vertically upright position. In this state, the plurality of vertical panels 30 are rotated by 90° such that only the side surfaces thereof are exposed to the front. Consequently, the advertising image printed on the front surfaces is not shown. Another image, printed on the side surfaces of the plurality of vertical panels 30, may be exposed. It is therefore possible to display different advertising images in the horizontal position and the vertical position.

In addition, since all of the bottom portions of the plurality of vertical panels 30 are pivotably attached to the lower arm 60, the plurality of vertical panels 30 stay upright by a predetermined angle instead of being oriented completely vertical.

In the position in which the upper arm 20 is completely upright, the entrance or the exit is opened, allowing the passage of a vehicle.

When the driving unit pivots the upper arm 20 in the reverse direction, the upper arm 20 returns to the horizontal position to block the passage of vehicles. Consequently, the plurality of vertical panels 30 rotate to the original position, thereby displaying the advertisement as illustrated in FIG. 2.

As described above, each of the plurality of vertical panels 30 rotates about the central rotary shaft 31 by 90° in response to the pivoting of the upper arm 20 from the horizontal position in which vehicular passage is blocked to the upright position in which the free end of the upper arm 20 is raised as high as possible.

FIG. 7 illustrates the rotating operation of each of the plurality of vertical panels 30. (a) in FIG. 7 illustrates the rotating operation in the horizontal position, and (b) in FIG. 7 illustrates that the upper arm 20 illustrated in FIG. 3 is rotated through a certain angle.

When the upper arm 20 pivots from the position illustrated in (a) of FIG. 7A, each of the plurality of vertical panels 30 remains in the upright position, thereby pivoting in relation to the pivot shaft 32. As illustrated in (b) of FIG. 7, the bevel gear 34, fixed to the upper arm 20, rotates following the upper arm 20, thereby rotating the bevel gear 33 engaged therewith.

When the bevel gear 33 rotates, each of the vertical panels 30 rotates about the central rotary shafts 31 and 37.

Accordingly, the front surfaces of the plurality of vertical panels 30 are exposed in the horizontal position of the upper arm 20, thereby displaying the advertising image. In the upright position, the side surfaces of the plurality of vertical panels 30 are exposed, such that the advertising image is not exposed. If another advertising image is printed on the side surfaces, another advertising image will be displayed in the upright position.

This operation can sufficiently attract the attention of passersby or drivers, thereby maximizing an advertising effect.

Since each of the plurality of vertical panels 30 is attached to the fitting assembly portions 31a and 37a, the plurality of vertical panels 30 can be easily assembled and disassembled from the arms. Advantageously, the existing advertising image can be rapidly replaced with a new advertising image.

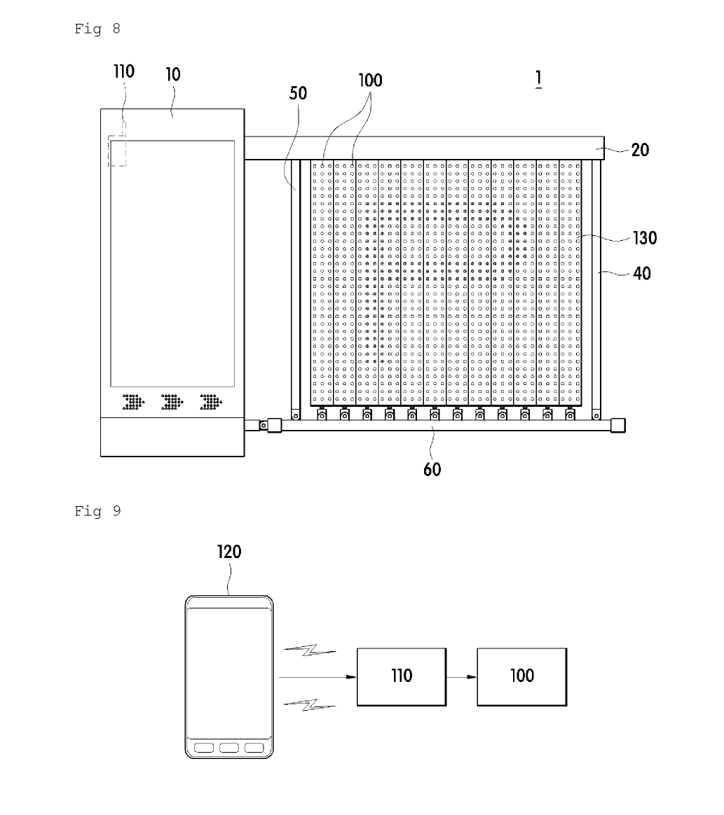

FIG. 8 and FIG. 9 illustrate a parking barrier according to another embodiment of the present disclosure. The parking barrier according to the present embodiment is different from the former embodiment in that a plurality of light-emitting diode (LED) lamps are provided on each of the plurality of vertical panels 130 in order to display an advertising image or the like.

Referring to FIG. 8 and FIG. 9, the plurality of LED lamps 100 are provided on each of the plurality of vertical panels 130, and each of the plurality of LED lamps 100 is controlled by a controller 110.

The controller 110 controls the plurality of LED lamps 100 based on a signal received via wireless communication. Thus, the manager can control advertising characters, copies, or images by transmitting signals to the controller 110 via wireless communication.

It is therefore possible to transmit a variety of characters in real time to the controller 110 using a radio communications terminal 120 from a remote place. It is also possible to send data, such as an emergency notification, a public service announcement, a commercial advertisement, and the like.

The radio communications terminal 120 may be implemented as a mobile communications device, such as a smartphone. Dedicated applications may be developed and installed in the radio communications terminal 120, enabling a business process in which a number of users can insert an advertisement in real time by paying a fee.

Although the exemplary embodiments of the present disclosure have been described for illustrative purposes, a person skilled in the art will appreciate that various modifications, additions and substitutions are possible, without departing from the scope and spirit of the present invention as disclosed in the accompanying claims.

| 1: parking barrier | |
|---|---|
| 10: control box | 20: upper arm |
| 30, 130: vertical panels | 31, 37: central rotary shaft |
| 32: pivot shaft | 33: bevel gear |
| 34: bevel gear | 35: assembly panels |
| 36: pin | 38: rotary block |
| 39: bracket | 40, 50: Connecting supports |
| 100: LED lamps | 110: controller |

120: radio communications terminal

What is claimed is:

1. A parking barrier having an advertising function, comprising:
a driving unit;
an upper arm controlling passage of vehicles, the upper arm being pivotable by the driving unit; and
a plurality of vertical panels, a top portion of each of the plurality of vertical panels being rotatably coupled to the upper arm such that each of the plurality of vertical panels stays in an upright position due to a weight thereof,
wherein each of the plurality of vertical panels comprises a pivot shaft having a bevel gear and a central rotary shaft having a bevel gear engaging with the bevel gear of the pivot shaft, whereby each of the plurality of vertical panels rotates on the central rotary shaft in response to the upper arm being pivoted to an upright position.

2. The parking barrier according to claim 1, wherein, when the upper arm pivots from a horizontal position in which the passage of vehicles is blocked to an upright position in which a free end of the upper arm is raised as high as possible, the plurality of vertical panels rotate about the central rotary shaft through 90°.

3. The parking barrier according to claim 1, further comprising a lower arm rotatably connected to a bottom portion of each of the plurality panels, thereby supporting the plurality of vertical panels.

4. The parking barrier according to claim 3, further comprising a connecting support extending in a top-bottom direction between the upper arm and the lower arm to connect and support the upper arm and the lower arm, with a top portion and a bottom portion thereof being rotatably coupled to the upper arm and the lower arm.

5. The parking barrier according to claim 1, further comprising a plurality of light-emitting diode lamps disposed on the plurality of vertical panels.

6. The parking barrier according to claim 5, wherein the plurality of light-emitting diode lamps are turned on and off by a controller, which controls the plurality of light-emitting diode lamps based on a signal received via wireless communication.
